(19) United States
(12) Patent Application Publication
(10) Pub. No.: US 2003/0002714 A1
(43) Pub. Date: Jan. 2, 2003

(54) Individual identifying apparatus

(75) Inventor: Kouji Wakiyama, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/179,162

(22) Filed: Jun. 25, 2002

(30) Foreign Application Priority Data
Jun. 27, 2001 (JP) P.2001-194813

(51) Int. Cl. G06K 9/00

(52) U.S. Cl. 382/117

(57) ABSTRACT

While both a forehead and a cheek are made in close contact to an eye position fixing portion, a space defined between an eye and a pinhole is shielded from extraneous light, and an iris is illuminated by infrared light of a lighting device. At this time, since a pupil diameter is defined in a self-control manner by receiving visible light of another lighting device, and also, a width of the iris is secured under stable condition, this iris is focused via the pinhole onto an image pick up element so that the iris can be photographed. Then, the acquired feature information of the iris is compared with registered feature information in order to execute the individual identifying operation.

### BACKGROUND OF THE INVENTION

The present invention is related to an individual identifying apparatus for identifying as to whether or not a person to be identified is made coincident with a registered individual. More specifically, the present invention is directed to an individual identifying apparatus for performing individual identification from an image obtained by photographing an iris of an eye.

Conventionally, individual identifying apparatus capable of identifying persons from each other by employing irides of eyes are known in this field. As an example of such individual identifying apparatus, one conventional individual identifying apparatus 100 disclosed in Japanese Patent Publication No. Hei. 9-212722 is indicated in FIG. 8. In this drawing, the individual identifying apparatus 100 is arranged by the pressure sensitive switch 101 for detecting presence of the person located in front of this individual identifying apparatus 100, the lighting device 102 for lighting face and the eyes of the person, the camera 103 for photographing the iris portion of this person, the power control unit 104 for controlling turn-ON/OFF operations of the power supplies of the lighting device 102 and the camera 103, and the identifying unit 105 for executing the individual identification based upon the picture of the camera 103. When presence of the person is detected by the pressure sensitive switch 101, both the power supply of the lighting device 102 and the power supply of the camera 103 are turned ON by the power control unit 104, and then, the iris portion of the eye is photographed by the camera 103. The identifying unit 105 may confirm as to whether or not this photographed person is identical to the registered person based upon the image of this photographed iris portion.

In the above-described conventional individual identifying apparatus, the dimension of this individual identifying apparatus is increased, and also, the high-precision camera is necessarily required so as to photograph the iris portion from the long distance, and furthermore, the camera angle thereof should be positioned in high precision. As a result, there is such a problem that the manufacturing cost of this individual identifying apparatus becomes high. In addition, there is another problem that the individual identification by this individual identifying apparatus may be readily and adversely influenced by extraneous light.

### SUMMARY OF THE INVENTION

The present invention has been made to solve the above-described problem, and therefore, has an object to provide a low-cost individual identifying apparatus capable of identifying individuals from each other without employing a high-precision camera, while a portability of this individual identifying apparatus is improved.

A first aspect of the present invention is featured by providing an individual identifying apparatus comprising: an image pick up unit for photographing either an iris or a retina of an eye of a person to be identified; a position fixing unit for fixing a position of the photographing unit, while extraneous light is interrupted under such a condition that the eye of the person to be identified is directed opposite to the photographing unit; a lighting unit including both photograph-purpose illuminating light emitting device for emitting photograph-purpose illuminating light and visible light emitting device for emitting visible light with respect to the eye of the person to be identified inside the position fixing unit; and individual identifying unit for identifying an individual based upon a picture of the eye which is photographed by the image pick up unit.

Also, a second aspect of the present invention is featured by that the individual identifying apparatus further comprises:

a light amount control unit for changing a light amount of the lighting unit; a state output unit for outputting information corresponding to a pupil diameter of the eye which is photographed by the image pick up unit; and an individual identifying unit for identifying an individual based upon the picture of the eye photographed by the image pick up unit when the output of the state output unit is reached to a predetermined value.

Also, a third aspect of the present invention is featured by that the light amount control unit controls a light amount of the lighting unit to allow the output of the condition output unit to be a predetermined value.

Also, a fourth aspect of the present invention is featured by that the individual identifying apparatus further comprises:

an intermittent control unit for controlling at least one of the photographing operation by the image pick up unit, the light emitting operation by the lighting unit, and the identifying operation by the individual identifying unit in an intermittent operation manner.

Also, a fifth aspect of the present invention is featured by that the individual identifying apparatus further comprises:

an identification control unit for controlling the individual identifying unit based upon luminance information of an image which is photographed by the image pick up unit.

With employment of the above-described arrangement, while one eye of the person to be identified is interrupted, or shielded from the extraneous light and this eye is fixed with being directed opposite to the image pick up unit, the light emitted from the lighting unit is irradiated onto the eye under such a condition that the adverse influence caused by the extraneous light is eliminated, and then, this lightened eye is photographed. As a result, the iris of the eye can be clearly photographed, so that the individual identification operation can be carried out based upon the image of this photographed iris under stable condition. Also, the pupil diameter is adjusted by irradiating the visible light emitted from the lighting unit to this one eye, and such an iris when the adjusted pupil diameter becomes a predetermined pupil diameter is photographed. As a result, the individual identification operation can be carried out with less error under more stable condition.

Also, since the eye of the person to be identified can be photographed within the short distance, such high-precision positioning operation of the image pick up unit is no longer required, and the compact individual identifying apparatus can be provided in low cost.

Furthermore, since the structural elements of the individual identifying apparatus are operated in the intermittent operation manner, power consumption of this individual identifying apparatus can be reduced.

### BRIEF DESCRIPTION OF THE DRAWINGS

FIG. 1 is an explanatory diagram for irradiating an outer view of an individual identifying apparatus according to an embodiment of the present invention;

FIG. 2 is an explanatory diagram for showing a sectional view of the structure, taken along a line A-A′ of FIG. 1;

FIG. 3 is a block diagram for indicating an arrangement of an individual identifying apparatus according to a first embodiment of the present invention;

FIG. 4 is a block diagram for showing an arrangement of an individual identifying apparatus according to a second embodiment of the present invention;

FIG. 5 is a block diagram for indicating an arrangement of an individual identifying apparatus according to a third embodiment of the present invention;

FIG. 6 is a block diagram for showing an arrangement of an individual identifying apparatus according to a fourth embodiment of the present invention;

FIG. 7 is a block diagram for indicating an arrangement of an individual identifying apparatus according to a fifth embodiment of the present invention; and

FIG. 8 is a diagram for showing the structural example of the conventional individual identifying apparatus.

### DETAILED DESCRIPTION OF THE PREFERRED EMBODIMENT

Referring now to drawings, embodiments of the present invention will be described. It should be understood that the same reference numerals are employed as those for denoting the same, or similar structural elements in the respective drawings.

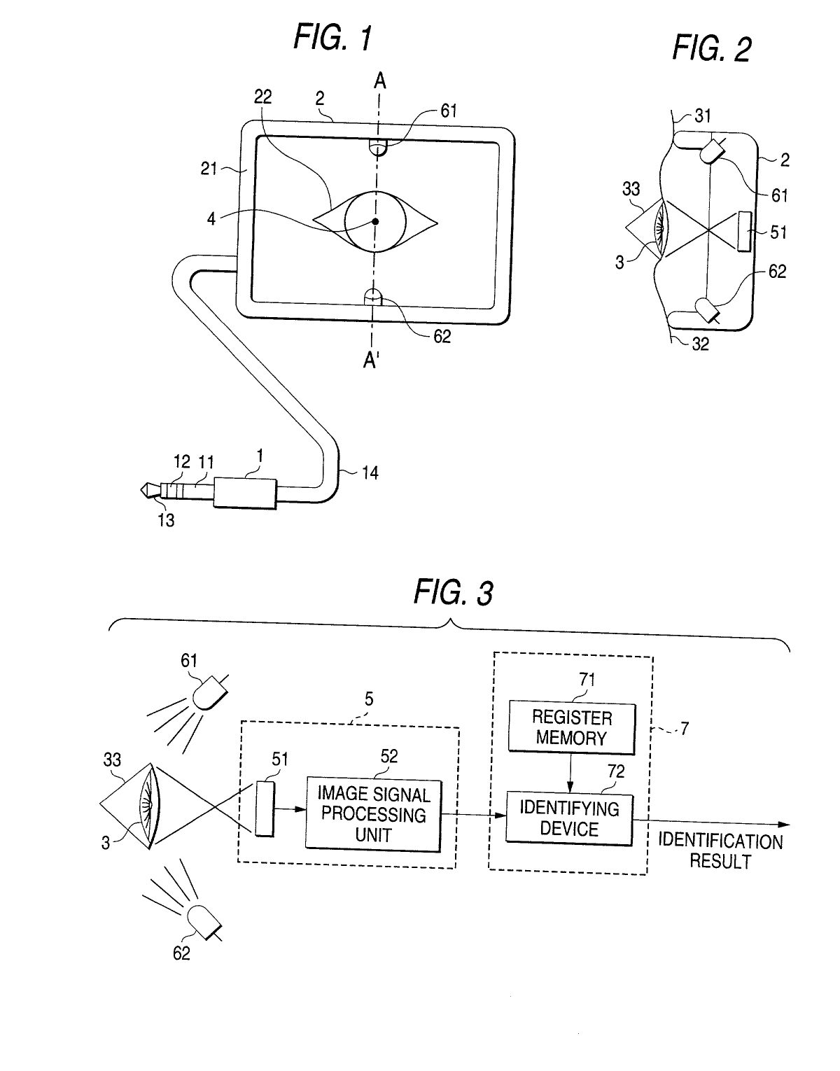

FIG. 1 is an explanatory diagram for showing an outer view of an individual identifying apparatus which is commonly used in a first embodiment to a fifth embodiment of the present invention (will be discussed later). FIG. 2 is a sectional view for explaining a structure of the individual identifying apparatus, taken along a line A-A′ of FIG. 1. In the drawings, a plug 1 is used to supply electric power, and also used to output a signal of an identification result. This plug 1 includes a ground terminal 11, a power supply terminal 12, and a signal output terminal 13. A cable 14 is connected to the individual identifying apparatus, and is used to supply electric power and signals via the plug 1 with respect to an external apparatus (not shown).

A peripheral edge of a housing 2 has a convex portion. While the peripheral edge of the housing 2 is depressed against either a forehead or a cheek of a person, this peripheral edge may shield an eye to be identified from extraneous light, and also may constitute an eye position fixing portion 21 which is directed opposite to an image pick up element 51. Then, a pinhole 4 is opened in a center of a concave portion surrounded by the eye position fixing portion 21, and this pinhole 4 is employed so as to focus the eye to be identified onto the image pick up element 51. Further, a FIG. 22 having an eye shape is drawn, while the pinhole 4 is set to a center. This FIG. 22 may induce the eye to be identified to a focusing point in order that an iris 3 may be easily photographed. Also, as a lighting light source used to photograph the iris 3, a lighting device 61 is provided on an upper portion of an inner edge of the eye position fixing portion 21, while this lighting device 61 is constructed of a light emitting element for emitting infrared rays, for example, an infrared light emitting diode. Similarly, another lighting device 62 is provided at a lower portion of the inner edge of the eye position fixing portion 21 so as to define widening (spread) of a pupil diameter, while this lighting device 62 is constituted by a light emitting element for emitting visible light, for instance, a green light emitting diode. Also, an electronic circuit capable of realizing an individual identification function (will be discussed later) is built in the housing 2.

Embodiment 1

FIG. 3 is a schematic block diagram for indicating an arrangement of an individual identifying apparatus according to a first embodiment of the present invention. An image pick up unit 5 is employed so as to photograph an iris 3 of a single eye 33. The image pick up unit 5 includes an image pick up element 51 and an image signal processing unit 52. The image pick up element 51 is a CCD image sensor having a sensitivity as to infrared rays. The image signal processing unit 52 performs a signal amplification, an A/D conversion, and other signal process operation. An individual identifying unit 7 executes individual identification operation based upon image information of the iris 3. This individual identifying unit 7 includes a register memory 71 and an identifying device 72.

As to the first embodiment of the present invention with employment of the above-described arrangement, operations thereof will now be explained.

First, since electric power is supplied from an external source (not shown) via the plug 1 to the individual identifying apparatus of this first embodiment, operations of the respective units of this individual identifying apparatus are commenced. Subsequently, a single eye 33 of a human being, or of an animal is reached toward the pinhole 4. At this time, when a subject to be identified is a person, the FIG. 22 may constitute a target while the eye 33 is approached, so that a positional relationship between the iris 3 and the pinhole 4 may be easily made coincident with each other.

When either the forehead 31 or the cheek 32 is made in close contact with the eye position fixing portion 21, a space defined between the single eye 33 and the pinhole 4 is shielded with respect to the extraneous light. While the infrared light is entered into this eye 33 from the lighting device 61, since the eye 33 of the person has no sensitivity as to the entered infrared light, the eye 23 may feel this condition as a dark scene and a pupil of this eye 33 is tried to be widened. However, since the visible light is also entered into the eye 33 from the lighting device 62, widening (spread) of the pupil may be suppressed. As previously explained, since a width of the iris 3 may be secured, this iris 3 having such a width is illuminated by the infrared light having a sufficiently high illuminance level emitted from the lighting device 61, and then, the illuminated iris 3 is focused via the pinhole 4 onto the image pick up element 51 having the sensitivity of the infrared light, so that such a sharp image of both an shape and a pattern of this iris 3 can be acquired.

The image of the iris 3 acquired in the above-described manner is converted into an electric signal by the image pick up element 51, and thereafter, this electric signal is converted by the image signal processing unit 52 into such an image format which may be easily processed by the individual identifying unit 7.

While feature information as to irides to be identified has been previously stored in the register memory 71, the identifying device 72 compares feature information as to the iris 3 acquired based upon the output information derived from the image signal processing unit 52 with the feature information of the iris stored in the register memory 71. If a difference of these compared feature information is located within a predetermined range, then the identifying device 72 identifies that the checked iris 3 is made incident with the registered iris, and then, encrypts this identified result to output this encrypted result via the plug 1 shown in FIG. 1 to an external appliance (not shown).

Furthermore, the signal of the identification result may be applied to such a security function as a password used to identify a user in an external appliance, and also, to various sorts of applications, for example, locking/releasing operations of a key.

As previously explained, in accordance with the first embodiment of the present invention, since the eye 33 to be identified may define the dimension of the pupil thereof in a self-definition manner without being adversely influenced by the extraneous light, the compact individual identifying apparatus having the simple arrangement can be realized, by which the image of the iris can be photographed under stable condition.

Embodiment 2

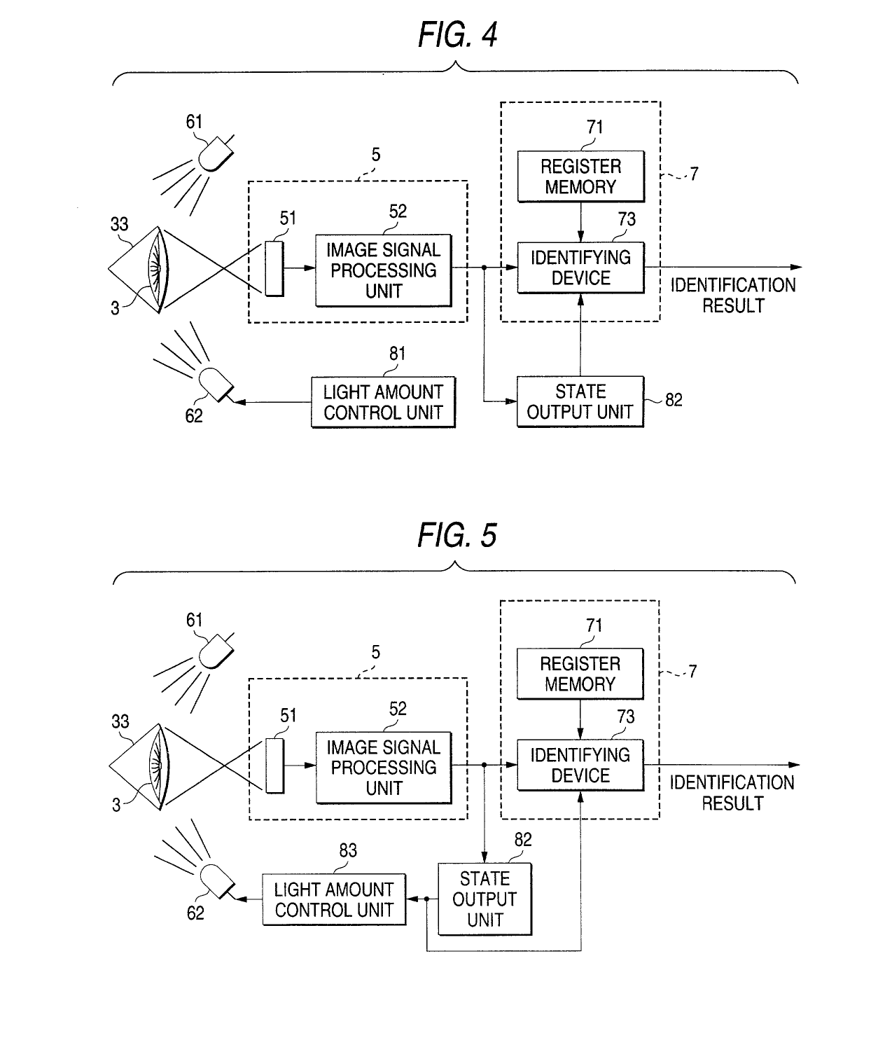

FIG. 4 is a schematic block diagram for indicating an arrangement of an individual identifying apparatus according to a second embodiment of the present invention. The individual identifying apparatus of the second embodiment includes a light amount control unit 81 and a state output unit 82 in addition to the arrangement of the first embodiment shown in FIG. 3, and an identifying device 73 replaced with the identifying device 72 of the first embodiment shown in FIG. 3. The light amount control unit 81 controls a light amount of the lighting device 62. The condition output unit 82 outputs information corresponding to the pupil diameter of the eye 33 photographed by the image pickup unit 5. The identifying device 73 executes the individual identification while using this information as a condition. It should be understood that the same reference numerals shown in FIG. 3 will be employed as those for denoting the same, or similar structures, and explanations thereof are omitted.

As to the second embodiment of the present invention with employment of the above-described arrangement, operations thereof will now be described.

When either the forehead 31 or the cheek 32 is made in close contact with the eye position fixing portion 21, a space defined between the single eye 33 and the pinhole 4 is shielded with respect to the extraneous light, and also, visible light emitted from the lighting device 62, the light amount of which is controlled by the light amount control unit 81, is entered into the eye 33 approached to the eye position fixing portion 21. As a result, the size of the pupil of the eye 33 becomes a preselected dimension. As previously explained in the first embodiment, while widening of the pupil is suppressed under stable condition, a width of the iris 3 may be secured, and also, both a shape and a pattern of the iris 3, which are illuminated by the infrared light emitted from the lighting device 61, may be clearly photographed by the image pick up unit 5.

Then, the image of the photographed iris 3 is converted into an electric signal by the image pick up element 51, and thereafter, this electric signal is converted by the image signal processing unit 52 into such an image format which may be easily processed by the individual identifying unit 7. Then, this image format signal is supplied to the identifying device 73 and the state output unit 82.

The state output unit 82 outputs to the identifying device 73, such information corresponding to the photographed pupil diameter of the eye 33. This identifying device 73 conducts feature information of the iris 3 in correspondence with the output information of the image signal processing unit 52 when the pupil diameter information supplied from the state output unit 82 may become an optimum condition with respect to an individual identification. Then, the identifying device 73 compares this conducted feature information of the iris 3 with the feature information of the iris to be identified which has been previously stored in the register memory 71, and thereafter, encrypts the identification result to output this encrypted identification result.

As previously explained, in accordance with the second embodiment, the light amount of the lighting device 62 is controlled by the light amount control unit 81 so as to control the pupil diameter of the eye 33 to become a predetermined dimension thereof, and further, the iris information at such a time when the pupil diameter may become the optimum condition with respect to the individual identification can be acquired by the condition output unit 82. As a consequence, precision of the individual identification can be improved.

Embodiment 3

FIG. 5 is a block diagram for indicating an arrangement of an individual identifying apparatus according to a third embodiment of the present invention. The individual identifying apparatus of the third embodiment includes a light amount control unit 83, while this light amount control unit 83 controls the light amount of the lighting device 62 employed in the second embodiment based upon the output of the state output unit 82. It should be understood that the same reference numerals shown in FIG. 4 will be employed as those for denoting the same, or similar structures, and explanations thereof are omitted.

As to the third embodiment of the present invention with employment of the above-described arrangement, operations thereof will now be described.

The state output unit 82 produces information corresponding to the pupil diameter of the eye 33, and then, outputs this produced information to both the identifying device 73 and the light amount control unit 83. The light amount control unit 83 controls a light amount of the lighting device 62 based upon this information. The illumination light emitted from the lighting 62 is entered into the eye 33. As a result, as previously explained in the first embodiment, while widening of the pupil is suppressed, a width of the iris 3 may be secured, and also, both a shape and a pattern of the iris 3, which are illuminated by the infrared light emitted from the lighting device 61, may be clearly photographed by the image pick up unit 5. The state output unit 82 produces information in response to the iris diameter from the image of the photographed iris 3.

In accordance with this manner, such a control close loop may be formed from the lighting device 62 via the eye 33, the image pick up unit 5, the condition output unit 82, the light amount control unit 83 to the lighting device 62 in this sequence. As a consequence, the pupil diameter of the eye 33 is correctly controlled to become the proper dimension, and both the shape and the pattern of the iris 3 can be more clearly photographed by the image pick up unit 5. Furthermore, since the iris information at such a time when the pupil diameter may become the optimum condition with respect to the individual identification can be acquired by the condition output unit 82, precision of the individual identification can be highly improved.

Embodiment 4

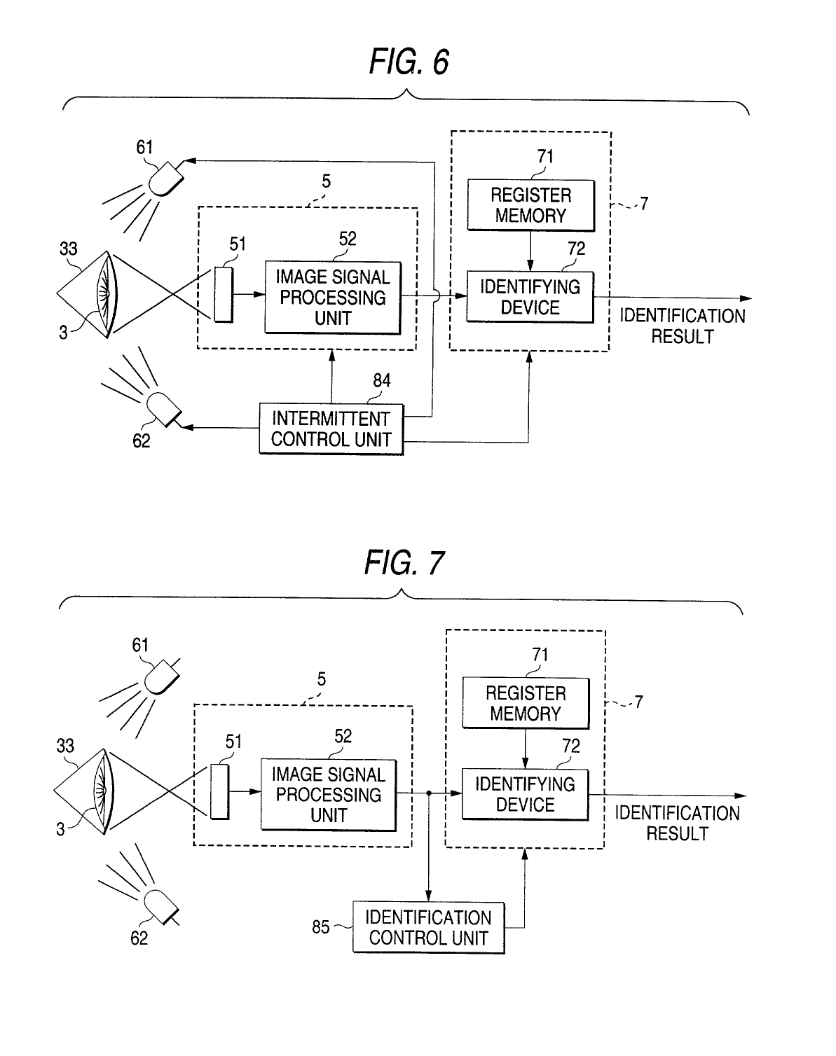

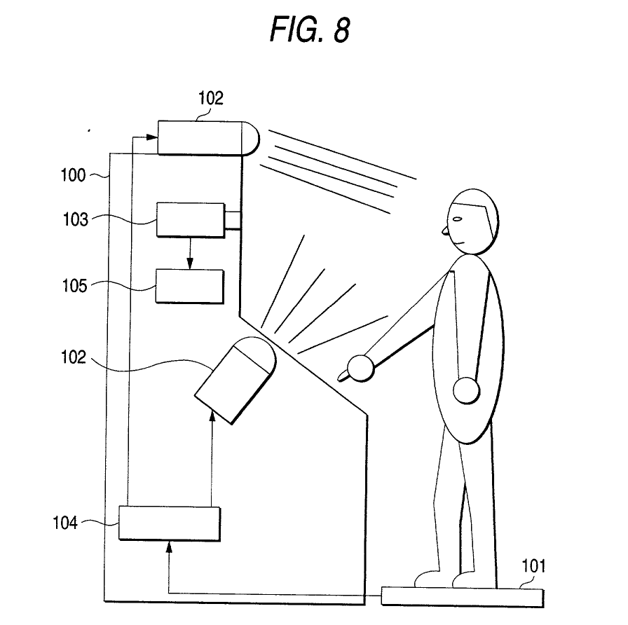

FIG. 6 is a block diagram for indicating an arrangement of an individual identifying apparatus according to a fourth embodiment of the present invention. The individual identifying apparatus of the fourth embodiment is arranged by newly employing an intermittent control unit 84 in the individual identifying apparatus of the first embodiment shown in FIG. 3, while this intermittent control unit 84 controls the image pick up unit 5, the individual identifying unit 7, the lighting device 61, and the lighting device 62 in an intermittent operation manner. It should be understood that the same reference numerals shown in FIG. 3 will be employed as those for denoting the same, or similar structures, and explanations thereof are omitted.

The intermittent control unit 84 controls input/output operations of signals as to the image pick up unit 5 and the individual identifying unit 7, so that the functions of the respective units can be intermittently operated, or intermittently stopped. Also, since the intermittent control unit 84 controls to drive the lighting device 61 and the lighting device 62, the light emitting operations thereof can be controlled. Alternatively, this intermittent control unit 84 may ON/OFF-control a supply of electric power to the respective units, separately.

As previously described, in accordance with the fourth embodiment of the present invention, in addition to the above-described effect of the first embodiment, the operations defined from the image pick up operation of the iris 3 up to outputting of the individual identification result can be carried out in the intermittent manner. Furthermore, either a portion or all of power supplying operations under the control management is interrupted during a rest time period, so that reductions of power consumption can be improved.

Embodiment 5

FIG. 7 is a block diagram for indicating an arrangement of an individual identifying apparatus according to a fifth embodiment of the present invention. The individual identifying apparatus of the fifth embodiment is arranged by newly employing an identification control unit 85 in the individual identifying apparatus of the first embodiment shown in FIG. 3, while this identification control unit 85 derives luminance information from image information photographed by the image pickup unit 5, and operates the individual identifying unit 7 in such a case that a level of this derived luminance information exceeds a predetermined value. It should be understood that the same reference numerals shown in FIG. 3 will be employed as those for denoting the same, or similar structures, and explanations thereof are omitted.

As to the fifth embodiment of the present invention with employment of the above-described arrangement, operations thereof will now be described.

First, when individual identification is commenced, the single eye 33 of the person is approached toward the pinhole 4. At this time, since the single eye 33 is located far from both the lighting device 61 and the lighting device 62 until the single eye 33 is reached to a predetermined position required for eye photographing operation, an illuminance level at this single eye 33 becomes a shortage of the necessary illuminance level, and thus, luminance of the photographed image is brought into a low luminance condition. The identification control unit 85 separates a luminance signal from a picture signal obtained by the image pick up unit 5 so as to derive such a luminance information, and when the luminance level of this derived luminance information is lower than, or equal to a preselected value, the identification control unit 85 executes the control operation in such a manner that either a portion or all of power supplies to the individual identifying unit 7 is interrupted.

On the other hand, when the eye 33 is approached to the pinhole 4 and both the forehead 31 and the cheek 32 are made in close contact to the eye position fixing portion 21, the space defined between the eye 2 and the pinhole 4 is shielded from the extraneous light, so that a sufficiently high illuminance level at the eye 33 may be secured by both the lighting device 61 and the lighting device 62. Then, a luminance level of a picture signal derived from the image pick up unit 5 which photographs this sufficiently illuminated eye 33 may be increased and then may exceed a predetermined value. At this stage, the identification control unit 85 controls to commence the supply of electric power to the individual identifying unit 7, so that this individual identifying unit 7 commences the individual identifying operation based upon the output information of the image pick up unit 5.

As previously explained, in accordance with the fifth embodiment, in addition to the above-described effect achieved by the first embodiment, the individual identifying operation can be arbitrarily carried out, so that the reduction of the power consumption can be improved.

It should be noted that in the descriptions of the first embodiment to the fifth embodiment, the iris is photographed as the information of the individual identification. Alternatively, even when a retina is photographed, the individual identifying operation of the present invention may be similarly carried out.

Also, such an example has been described. That is, the feature information as to the irides of the subject to be identified has been previously stored in the register memory 71. Alternatively, even when images obtained during registering operation are stored in this register memory 71, a similar effect may be achieved.

Also, such an example has been explained. That is, the pinhole 4 is employed to focus the iris image. Alternatively, a lens may be employed to focus the iris image.

Also, the lighting device 61 and the lighting device 62 are arranged at the upper and lower portions of the inner edge of the eye position fixing portion 21. Alternatively, these lighting devices 61 and 62 may be arranged on right and left portions of this inner edge. Furthermore, even when these lighting devices 61 and 62 may be arranged in either a linear-shaped light source or a plane-shaped light source, a similar effect may be achieved.

In addition, such an example has been explained in which the individual identifying apparatus is connected via the plug 1 to the external appliance. Alternatively, even when other connection modes such as connectors, terminal boards, and appliance built-in modes are employed, a similar effect may be achieved.

As previously described in detail, in accordance with the present invention, while the eye corresponding to the subject to be identified is shielded from the extraneous light, the iris can be photographed by irradiating the infrared light to this iris at the sufficiently high luminance level under such a condition that the pupil diameter is defined by using the visible light. As a consequence, the individual identifying operation can be carried out in high precision under stable condition without being adversely influenced by the extraneous light. Also, while such a high-precision camera is not employed, the individual identifying operation can be carried out in high practical levels by the low-cost individual identifying apparatus having the superior portability.

What is claimed is:

1. An individual identifying apparatus comprising:
an image pick up unit for photographing one of an iris and a retina of an eye of a person to be identified;
a position fixing unit for fixing a position of said image pick up unit, while extraneous light is shielded under such a condition that the eye of the person to be identified is directed opposite to said image pick up unit;
a lighting unit including both an photographing illuminating light emitting device for emitting illuminating light and a visible light emitting device for emitting visible light with respect to the eye of the person to be identified inside said position fixing unit; and
an individual identifying unit for identifying an individual based upon a picture of the eye which is photographed by said image pick up unit.

2. The individual identifying apparatus as claimed in claim 1, further comprising:
a light amount control unit for changing a light amount of said lighting unit;
a state output unit for outputting information corresponding to a pupil diameter of said eye which is photographed by said image pick up unit; and
an individual identifying unit for identifying an individual based upon the picture of the eye photographed by said image pick up unit when the output of said state output unit is reached to a predetermined value.

3. The individual identifying apparatus as claimed in claim 2, wherein said light amount control unit controls a light amount of said lighting unit to allow the output of said condition output unit to be a predetermined value.

4. The individual identifying apparatus as claimed in claim 1, further comprising an intermittent control unit for controlling at least one of the photographing operation by said image pick up unit, the light emitting operation by said lighting unit, and the identifying operation by said individual identifying unit in an intermittent operation manner.

5. The individual identifying apparatus as claimed in claim 1 further comprising an identification control unit for controlling said individual identifying unit based upon luminance information of an image which is photographed by said image pick up unit.
